(19) United States
(12) Patent Application Publication
(10) Pub. No.: US 2025/0289032 A1
(43) Pub. Date: Sep. 18, 2025

(54) PROCESSING OF TRONA ORES USING SENSOR-BASED ORE SORTING SYSTEMS

(71) Applicant: TATA Chemicals North America Inc., Sandy, UT (US)

(72) Inventors: Eric S. Fagley, Rock Springs, WY (US); Timothy S. McCoy, South Jordan, UT (US)

(73) Assignee: TATA Chemicals North America Inc., Sandy, UT (US)

(21) Appl. No.: 18/605,211

(22) Filed: Mar. 14, 2024

(51) Int. Cl. B07C 5/02; B07C 5/34; B07C 5/36

(52) U.S. Cl. CPC B07C 5/02; B07C 5/3416; B07C 5/366

(57) ABSTRACT

An ore-sorting system includes a trona ore screen system including an ore crusher and a filter. The ore-sorting system further includes a beneficiation system having a sensor and a separator. The separator includes an identification system configured to accept or reject ore. The accepted ore is deposited in a bin and the rejected ore is ejected with a high-pressure air jet.

### BACKGROUND

Trona is a soft sodium carbonate mineral that can range from colorless, gray-white to light yellow. Its chemical formula is Na₃H(CO₃)2*2H₂O. Trona is mined and processed to be converted to soda ash, which is used to make a variety of products including glass, baking soda, laundry detergent, paper, textiles, and also aids in the process of supplying potable water and clean air. The finished desired product is known as soda ash (Na₂CO₃). The products produced from soda ash can either be dense, intermediate, or light soda ash. The chemical composition of each grade of soda ash stays the same, while the density of the product may differ.

The Green River Basin in Wyoming hosts the world's largest trona deposit, supplying approximately 90% of soda ash in the United States of America. The beds of trona were deposited during the Eocene Geological Epoch in an ancient freshwater lake known as Lake Gosiute. The mineral trona is an evaporite mineral that formed in shallow waters that evaporated rapidly and continuously over millions of years. These waters would have needed to have an input of elevated levels of Na⁺ and HCO³⁻ ions. These constituents of trona were produced by the leaching of extensive pyroxene-andesite volcanic ash layers combined with a seasonal influx of carbonate-rich sediments from stream waters entering the depositional basin. Other processes that produced carbonate and bicarbonate include bacterial reduction of sulfate and the precipitation of calcium carbonate by algae. The precipitation of trona required the presence of an abundance of carbon dioxide, which was likely generated by the biogenic decay of plant and aquatic sources.

Subterranean thermal springs had also played a large part in dissolving alkaline carbonates, sodium, calcium, silica, and bicarbonate ions. For a period of 4 million years, the lake underwent several cycles of filling and evaporating leaving behind beds of trona interbedded with marlstone, limestone, oil shale, and sandstone-mudstone. During periods which saw higher water levels, algae along with clastic sediments and authigenic minerals, formed organic marlstones and beds of low to high-grade oil shale.

Dense soda ash has a bulk density of 60-66 lb/ft³. This grade of soda ash is produced by hydrating light soda ash and then dehydrating using calcination to form denser crystals. It is preferred over light soda ash for the glass manufacturing industry because the light variety leads to frothing in glass melt. Light soda ash has a bulk density of 32-39 lb/ft³. It forms from calcining the sodium sesquicarbonate precipitate that is recovered from the carbonation towers or vacuum crystallizers. Light soda ash is preferred by chemical and detergent manufactures because of its ability to dissolve readily. The light-intermediate product has a bulk density of 50 lb/ft³. This grade of soda ash is used in some detergents, as well as bath salts.

### SUMMARY

Embodiments disclosed herein include systems, assemblies, and methods for processing of trona ores using sensor-based ore sorting systems with the objective of removing waste and low-grade material to enrich plant feed. In some embodiments, an ore sorting system can include a trona ore screen system having an ore crusher and a filter, the screen system can be configured to produce an ore feed including ore particles having a predetermined size. The ore sorting system also can include a beneficiation system that receives the ore particles having a predetermined size, the beneficiation system configured to increase an economic value of the trona ore by removing gangue material, resulting in a high-grade ore product. In an example, the beneficiation system can include a sensor and a separator having an identification system configured to accept or reject ore. In some examples, accepted ore can be deposited in a bin and rejected ore can be ejected with a high-pressure air jet. In at least one example, the trona ore can include trona interbedded with at least one of a marlstone, limestone, oil shale, sandstone, or mudstone.

In some examples, the ore crusher pulverizes a raw ore into an ore particle. The ore particle can include a diameter between about ⅛ inch and about 4 inches. In at least one example, the sensor can identify trona ore having a trona concentration greater than 95%. The beneficiation system can include a dry separation including at least one of density, magnetic, electrostatic, optical, X-ray, or infrared separation.

In some examples, the separator can include a first trona ore feed having a large ore particle diameter and a second ore feed having a small ore particle diameter, wherein the first ore feed is fed to a first beneficiation system and the second ore feed is fed to a second beneficiation system. In some examples, the first trona ore feed and second trona ore feed are in series. In other examples, the first trona ore feed and second trona ore feed are in parallel.

In at least one example, an ore sorting system can include a feed intake having a hopper configured to receive trona ore particles and a conveyer belt that receives the trona ore particles from the hopper and carries the trona ore particles to be evaluated. In some examples, the trona ore particles can be configured as a monolayer on the conveyer belt. The ore sorting system can further include a sensor configured to examine the trona ore particles on the conveyor belt to evaluate the concentration of trona in the trona ore particles and identify a high-grade ore product and an ore separator that divides the high-grade ore product from a waste material based on the results of the sensor. In some examples, the sensor includes an XRT source configured to analyze the trona ore particles for their X-ray signal attenuations and determine atomic density of the trona ore particles. In some examples, the ore separator can include an identification system configured to accept or reject each trona ore particle. In the example, an accepted trona ore particle can be deposited in a bin and a rejected trona ore particle can be ejected with a high-pressure air jet. In some examples, the ore sorting system can further include a secondary ore sorter. The secondary ore sorter can be configured to analyze rejected trona ore particles to identify and further separate misclassified trona ore particles.

In some examples, a method for purification of trona can include screening trona ore to produce an ore feed comprising ore particles having a predetermined size, identifying an impurity content of the ore particles by a beneficiation system that receives the ore particles having a predetermined size. In some examples, the beneficiation system can be configured to increase an economic value of the trona ore by removing gangue material, resulting in a high-grade ore product. In some examples, the method further includes separating the ore particles using air-jet diverters based on a purity threshold. In an example, an accepted ore is deposited in a bin and rejected ore is ejected with a high-pressure air jet. In some examples, beneficiation of the particle can include utilizing X-ray transmission-based imaging to identify ore purity. In some examples, the ore feed can include ore particles having a diameter between about ⅛ inch and about 4 inches. In some examples, the purity threshold includes about 90% trona. In at least one example, the method can further include crushing the trona ore prior to screening the trona ore.

In some examples, the ore feed can include a first ore feed having a large ore particle diameter and a second ore feed having a small ore particle diameter. In an example, the first ore feed can be fed to a first beneficiation system and the second ore feed can be fed to a second beneficiation system. In an example, the first beneficiation system and the second beneficiation system can be in series. In another example, the first beneficiation system and the second beneficiation system can be in parallel.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a flowchart for the monohydrate processing of raw trona ore, according to an embodiment.

FIG. 2 is a flowchart for processing and sorting of trona ore, according to an embodiment.

FIG. 3 is a side view of an ore-sorting system, according to an embodiment.

FIG. 4 is a block flow diagram for processing trona ore including having two sorters working in parallel for feeding different rock size ratios, according to an embodiment.

FIG. 5 is a block flow diagram for sorting trona ore, according to an embodiment.

FIG. 6 is a block flow diagram for processing trona ore including having two sorters working in series for scavenging trona ore from a waste stream, according to an embodiment.

FIG. 7 is a side view of an ore-sorting system using a secondary XRT sensor, according to an embodiment.

### DETAILED DESCRIPTION

Embodiments disclosed herein are related to assemblies, systems, and methods of processing trona and ore sorting. The assemblies, systems, and methods of ore sorting include a method for separating trona ore from waste rock in trona mines using sensor-based ore sorting systems. In some examples, the trona ore can be physically separated as low grade and waste materials before the ore is processed to upgrade the feed that goes into the plant, which is also known as pre-concentration. Pre-concentration can lower the overall cost per mass of trona recovered, which can subsequently lower the cut-off grade of the material that can be mined.

Soda ash can either be produced synthetically or naturally. In some examples, soda ash can be produced by either the less prevalent Leblanc method or the more prominent Solvay process. In the Leblanc method, sodium sulfate is produced by treating salt with sulfuric acid to produce a salt cake. The cake is then roasted with limestone and coal in a rotary furnace to obtain a sodium carbonate and calcium sulfide. This mixture, known as black ash, is then dissolved in water, concentrated, and crystallized to produce sodium carbonate. The Solvay process utilizes brine, limestone, and ammonia (as a catalyst) to produce sodium carbonate. The Solvay process consists of several complex steps consisting of brine purification, formation of sodium hydrogen carbonate, formation of sodium carbonate, and the recovery and recycling of ammonia. The product of the Solvay process is sodium carbonate.

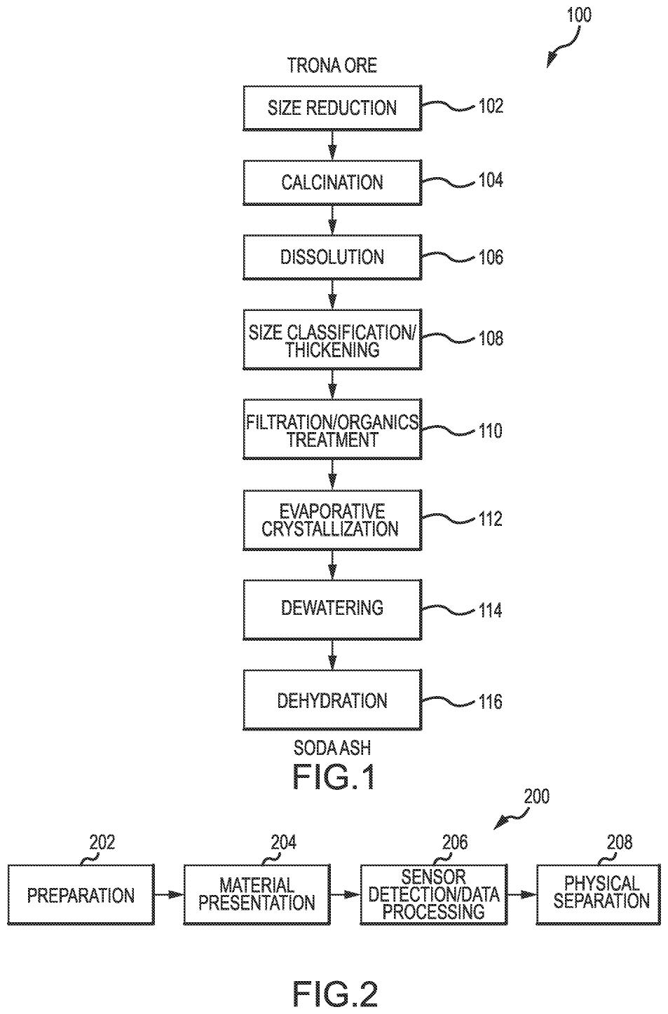

To convert natural trona ore to soda ash, a multi-step purification process is needed. The production of soda ash can either be achieved by the monohydrate or the sesquicarbonate process. The monohydrate method is the preferred method over the sesquicarbonate method due to the raw trona ore leaching more slowly than the calcined ore in the sesquicarbonate method, and because the leach solution requires more extensive purification. FIG. 1 is a flowchart for the monohydrate processing of raw trona ore to make soda ash. Trona and soda ash are naturally soluble in water, however, raw trona ore includes minerals that are insoluble. These insolubles are finely disseminated throughout the beds and are composed of clay minerals/organics, dolomite, calcite, quartz, feldspar, pyrite, and shortite. The insoluble material are separated from the trona ore to produce a trona ore feed suitable for further processing and for making soda ash.

The monohydrate process 100 can include a first act 102 of precision crushing and screening of the ore to reduce the size of the ore for further processing. The ore can then be calcinated in a kiln in act 104 to drive off unwanted gases. The heat from the kiln converts the ore to crude sodium carbonate. In some examples, calcining of the raw ore is done in rotary calciners at ca. 120° C. or higher. In some examples, a rotary calciner can include a large, rotating cylinder or drum, through which process gas is passed, allowing it to directly contact the material to cause the intended reaction. In some examples, the drum can be externally heated to avoid direct contact between the material and process gas, however, direct-fired units are also utilized.

In act 106, water can then be added to dissolve the crude sodium carbonate. Tailings generated from the calcining process in act 106 are discharged to the tailings tank. The tailings tank also receives fly ash and bottom ash generated from using coal to fire the calcining kiln and the steam boiler. In some examples, as shown in act 108, this waste material can be treated in a thickening tank by adding anionic and cationic flocculants to the tailings to increase the solids content from about 10% to about 50% solids. In some examples, the solution formed is then filtered to remove any impurities in act 110. Water contained within the solution can be evaporated in act 112 to form a soda ash crystal slurry. In act 114, a centrifuge is then used to separate the remaining water from the soda ash crystals. The soda ash will then be sent to rotary driers for dehydration in act 116, which produces the final product.

The first step of the process, act 102, can include the assemblies, systems, and methods of ore sorting described in greater detail below. Ore sorting includes crushing and screening the trona ore, then using different types of sensors to distinguish the physical characteristics of the ore to separate high-grade ore from waste rock so that only rocks containing a high amount or trona is sent for further processing while the gangue (i.e., valueless minerals) material accumulates as waste rock.

FIG. 2 is a flowchart illustrating a process 200 for sorting of trona ore, according to an embodiment. Ore sorting can be employed at any stage of a mining project. However, the ore sorting is beneficial in a progressively decreasing mine grade to make ore that was once deemed uneconomical to now be mined economically. This can be done because the cut-off grade of the deposit can be substantially lowered. A cut-off grade is defined as the minimum grade required for a mineral or metal to be economically mined or processed. Material above the cut-off grade is considered ore, while the material below is considered waste. In some examples, ore sorting can be typically utilized to pre-concentrate the process plant feed. Other advantages of ore sorting include extending mine life and prolonging mining operations when the grade of the deposit progressively decreases; without having to increase mill size. In some examples, before a mine is in production, ore sorting can reduce the size of the processing plant required for a project. Energy consumption can also be substantially lowered per tonne of concentrate produced and ore sorting also can reduce the amount of grinding of waste material which lowers the wear on the circuit. Ore sorting can also be considered more environmentally friendly by reducing the volume of water and reagent necessary to process the ore.

In the process 200, which is a general overview of the system and processing method, can include the preparation of the ore in act 202. In some examples, the particles to be sorted are crushed and screened to an applicable size. In some examples, the system can include an ore crusher that pulverizes a raw ore into an ore particle comprising a diameter between about ⅛ inch and about 4 inches. In some examples, these particles can be crushed to include diameters less than 12 inches. In other examples, the particles can include diameters less than 10 inches, less than 8 inches, less than 6 inches, less than 4 inches, or less than 2 inches. In some examples the particles crushed can include a particle size in ranges between about ⅛ inch and about 8 inches. Other ranges can include between about ⅛ inch and about 1 inch, between about 1 inch and about 3 inches, between about 3 inches and about 4 inches, between about 4 inches and about 6 inches, between about 6 inches and about 9 inches, between about 9 inches and about 12 inches, between about 3 inches and about 8 inches, or between about ½ inch and about 4 inches. Particle size has an impact on throughput and the number of particles which can be detected, evaluated, and ejected per unit time. Larger particle sizes can decrease throughput for the system, in some examples.

Process 200 can further include act 204, which includes material presentation. In some examples, the individual particles that have been crushed can be introduced into a feed intake or hopper where it enters a vibrating feeder configured to disperse the particles onto a fast-moving conveyor belt. In some examples, the particles can be organized on the conveyor in a monolayer such that each side of the particle can be analyzed, and such that every particle can be scanned. For some sensors and detection modes, it may be necessary to isolate each particle from its neighbors. The particles must also follow a defined path between detection point and ejection point to ensure that there is no misplacement and that the identified particles can be accepted or rejected as determined by a sensor.

The sensing of the particles is included in act 206. In some examples, the conveyor belt can be configured to pass under an X-ray transmission (XRT) source, which transmits X-rays through the particles and material towards a detector to determine atomic density of each particle sample. The sensor can be linked to a computer algorithm that can be configured to make a real-time decision to accept or reject an analyzed particle.

The acceptance or rejection of the particle can include an act 208. In act 208 the particles are physically separated based on the decision on whether to accept or reject the particles. In some examples, the rejected particles are ejected from a high-pressure air valve connected to a compressor. The accepted particles fall into an “accept” bin, where the accepted particles can be further processed. In some examples, in the event the particles are too closely spaced, or located too closely together while they approach the ejector on the conveyor, some of the ore can be erroneously ejected along with the rejected and/or waste particles. In some examples, the rejected waste particles from the sorting in act 208 can be sent to a secondary ore sorter or a “scavenger” sorter. The scavenger sorter can be configured to analyze any waste and/or rejected particles that are misclassified and/or erroneously rejected. As such, sorting a second time with the scavenger sorter can minimize the loss of trona at this stage.

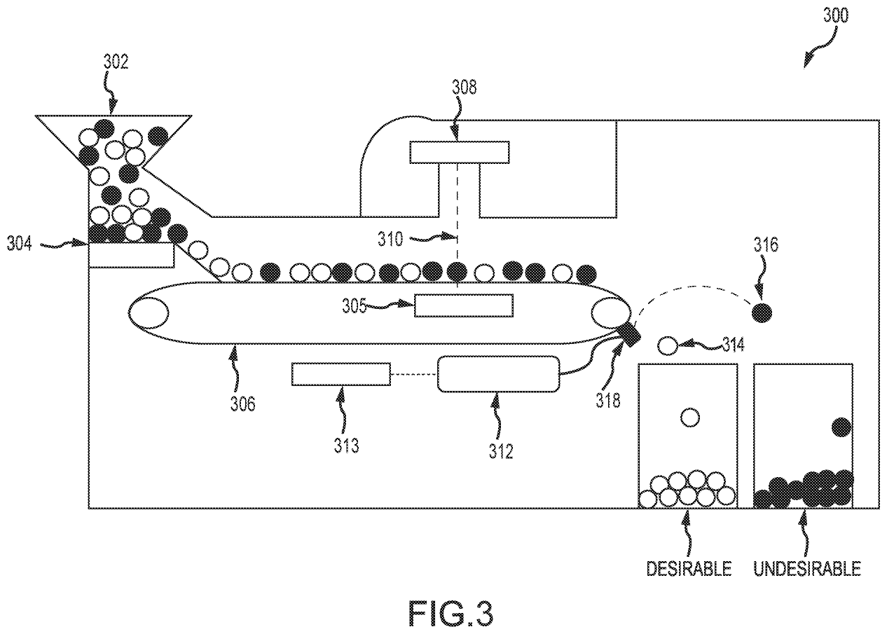

FIG. 3 is an isometric view of an ore-sorting system 300, according to an embodiment. In some examples, the ore-sorting system 300 includes a feed intake 302 that includes a hopper 304 configured to receive trona ore particles. In some examples, prior to the feed intake 302, the ore sorting system can include a trona ore screen system that includes an ore crusher and a filter as described in the process 200 above. The ore crusher can be configured to pulverize a raw ore into an ore particle comprising a diameter between about ⅛ inch and about 4 inches. In some examples, the ore-sorting system can include a beneficiation system 308 that includes a sensor. In some examples, the sensor identifies trona ore having a predetermined trona concentration. For example, the sensor can be configured to identify trona ore that includes a trona concentration greater than 80%, greater than 90%, greater than 95%, or greater than 98%.

In some examples, the beneficiation system 308 can include a conveyer belt 306. The trona ore particles can be configured as a monolayer on the conveyer belt 306. In some examples, the conveyor belt can operate at a predetermined speed. The speed of the conveyor belt 306 can be configured to ensure the trona ore is disposed in a monolayer prior to the sensor. In some examples, the conveyor belt can have a variable speed. The speed of the conveyor belt 306 can be manually controlled or automatically controlled. In some examples, the trona ore particles can be arranged in a monolayer by the combination of the speed of the conveyor belt 306 and the function of the hopper 304. For example, the hopper 304 can be configured to vibrate to better distribute the trona ore particles. In some examples, the conveyor belt 306 can include fins or other suitable partitions configured to arrange the trona ore particles in a monolayer and also prevent the trona ore particles from falling off the conveyor belt 306. In some examples, such as for some sensors and detection modes, it may be necessary to isolate each particle from its neighbors. In some examples, the trona ore particles also follow a defined path between detection point and ejection point to ensure that there is no misplacement and that the right type of particles (e.g., those having a predetermined trona concentration) are being accepted and/or rejected.

In some examples, the beneficiation system 308 can include any suitable dry separation procedure. For example, the beneficiation system 308 can include at least one of density, magnetic, electrostatic, optical, X-ray, or infrared separation. The beneficiated trona fraction contains significantly fewer impurities than the mined ore. The drying process is carefully controlled to avoid calcination of trona. Additional details include options for concurrent milling and drying, achieving specific weight ratios of NaHCO₃:Na₂CO₃, and reducing particle size for flue gas desulfurization. This method produces dry trona sorbent suitable for flue gas treatment, effectively reducing sulfur oxide emissions from combustion processes.

In some examples, the beneficiation system 308 can include an X-ray sensor 305. The X-ray sensor 305 can be configured to analyze the trona ore particles for their X-ray signal attenuations and determine atomic density of the trona ore particles. In some examples, the sensor 305 can capture the transmitted X-rays and the data can be sent to a computer 313 that is configured to use a pre-determined algorithm to decide whether to keep the particles or reject them as waste. The computer 313 can conduct the analysis instantaneously.

In some examples, the conveyor belt 306 passes under a XRT source 308 which transmits X-rays 310 through the materials (i.e., the trona ore particles) towards a detector to determine an atomic density of each particle. The sensor 305 is linked to a computer algorithm that makes a real-time yes/no decision to accept or reject the trona ore particle.

In some examples, the ore sorting system 300 further includes an ore separator 312. In some examples, the separator 312 can include an identification system configured to accept or reject ore. In some examples, the accepted ore 314 can be deposited in a bin as a “desirable” and rejected ore 316 can ejected with a high-pressure air jet 318. In some examples, the separator 312 is an ore separator. In some examples, the trona ore can include trona interbedded with at least one of a marlstone, limestone, oil shale, sandstone, or mudstone. The desirable and/or accepted trona ore particles can include a trona concentration greater than a predetermined threshold (e.g., 90%). The rejected ore has a concentration of marlstone, limestone, oil shale, sandstone, or mudstone that is too high. In other words, the concentration of trona ore in the rejected ore is too low (e.g., less than 90%). The rejected ore 316 can be considered waste rock, rejected ore, and/or gangue materials.

In some examples, the separator 312 can include a first trona ore feed having a large ore particle diameter and a second ore feed having a small ore particle diameter. The diameter of the ore feed can be determined and/or produced in a crushing and screening system of the ore sorting system. In some examples, the first ore feed can be fed to a first beneficiation system and the second ore feed can be fed to a second beneficiation system. The first beneficiation system and the second beneficiation system can both include every and/or some of the components of the beneficiation system 308 discussed above. In some examples, the first trona ore feed and second trona ore feed are in series. For example, the ore sorting system can further include a secondary ore sorter. The secondary ore sorter can be configured to analyze rejected trona ore particles to identify and further separate misclassified trona ore particles. In other examples, the first trona ore feed and second trona ore feed are in parallel.

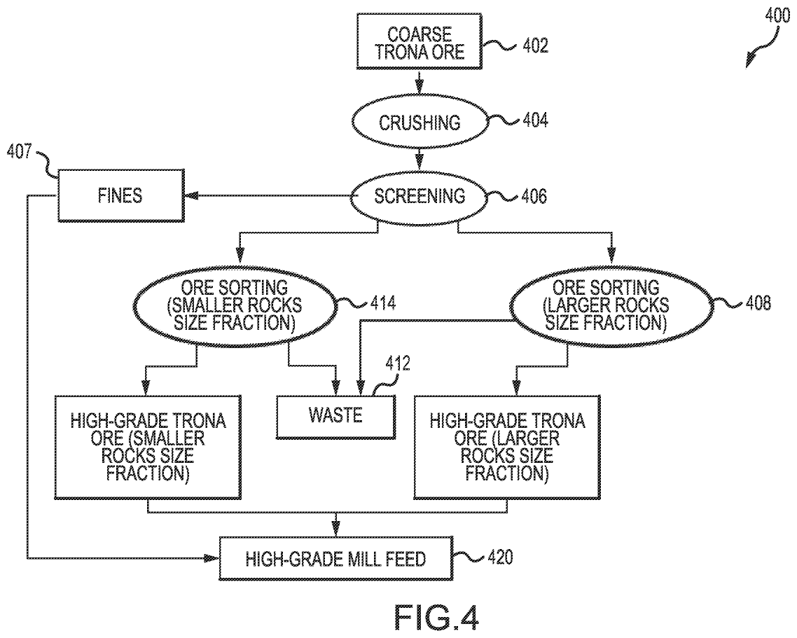

FIG. 4 is a flow diagram of a method 400 for the purification of trona, according to some embodiments. The method 400 for the purification of trona may utilize use any of the ore sorting systems and/or assemblies disclosed herein. The method 400 may include act 402, which includes mining and/or harvesting coarse trona ore. The coarse trona ore can include trona interbedded with at least one of a marlstone, limestone, oil shale, sandstone, or mudstone. The coarse trona ore can be mined by any suitable method known in the art to produce a crushable trona ore. Act 402 may be followed by act 404, which includes crushing the trona ore. In some examples, crushing the trona ore can include pulverizing a raw ore into an ore particle comprising a diameter between about ⅛ inch and about 4 inches. In some examples, these particles can be crushed to include diameters less than 12 inches. In other examples, the particles can include diameters less than 10 inches, less than 8 inches, less than 6 inches, less than 4 inches, or less than 2 inches. In some examples the particles crushed can include a particle size in ranges between about ⅛ inch and about 8 inches. Other ranges can include between about ⅛ inch and about 1 inch, between about 1 inch and about 3 inches, between about 3 inches and about 4 inches, between about 4 inches and about 6 inches, between about 6 inches and about 9 inches, between about 9 inches and about 12 inches, between about 3 inches and about 8 inches, or between about ½ inch and about 4 inches. Particle size has an impact on throughput and the number of particles which can be detected, evaluated, and ejected per unit time. Larger particle sizes can decrease throughput for the system, in some examples.

Acts 402, 404, and 406 of the method 400 are for illustrative purposes. For example, the acts of the method 400 may be performed in different orders, split into multiple acts, modified, supplemented, or combined. In an example, one or more of the acts of the method 400 may be omitted from the method 400. Any of the acts of the method 400 can include using any of the ore sorting assemblies or systems disclosed herein.

Act 406 includes screening trona ore to produce an ore feed comprising ore particles. The act 406 of screening may include utilizing any of the ore sorting assemblies or systems disclosed herein or other systems of screening and/or filtration known in the art. In some examples, act 406 may include screening to separate high-grade ore from waste rock so that only rocks containing high amount or trona. In other examples, the screening is for rock size, as shown in FIG. 4. In some examples, the trona ore is sorted in to fines 407, which can be sent directly to a mill feed for further processing, smaller rock size fractions, and larger rock size fraction.

Act 408 including ore sorting for larger rock size fraction and act 414 including ore sorting for smaller rock size fraction can be conducted in parallel. In other words, the ore feed can include a first ore feed including a large ore particle diameter and a second ore feed including a small ore particle diameter.

The ore sorting in acts 408 and 414 can include using a beneficiation system to determine the ore grade of the rock. For example, the beneficiation system can include at least one of density, magnetic, electrostatic, optical, X-ray, or infrared separation. In some examples, act 408 and 414 can include identifying an impurity content of the ore particles by a beneficiation system. In some examples, the beneficiation system of the particle comprises utilizing X-ray transmission-based imaging to identify ore purity. In some examples, the first ore feed can be fed to a first beneficiation system and the second ore feed can be fed to a second beneficiation system. In some examples, the first beneficiation system and the second beneficiation system are in series. In other examples, the first beneficiation system and the second beneficiation system are in parallel.

The waste can be disposed in act 412 in some examples. In other examples, the waste can be further analyzed for either a different grade of trona ore and/or reevaluate to ensure proper ore sorting was conducted in acts 408 and 414. The high-grade trona from the ore sorting can be send to a high-grade mill feed in act 420 for further processing. In some examples, the further processing includes dissolution, solution purification, crystallization to produce sodium sesquicarbonate, and calcination to produce soda ash.

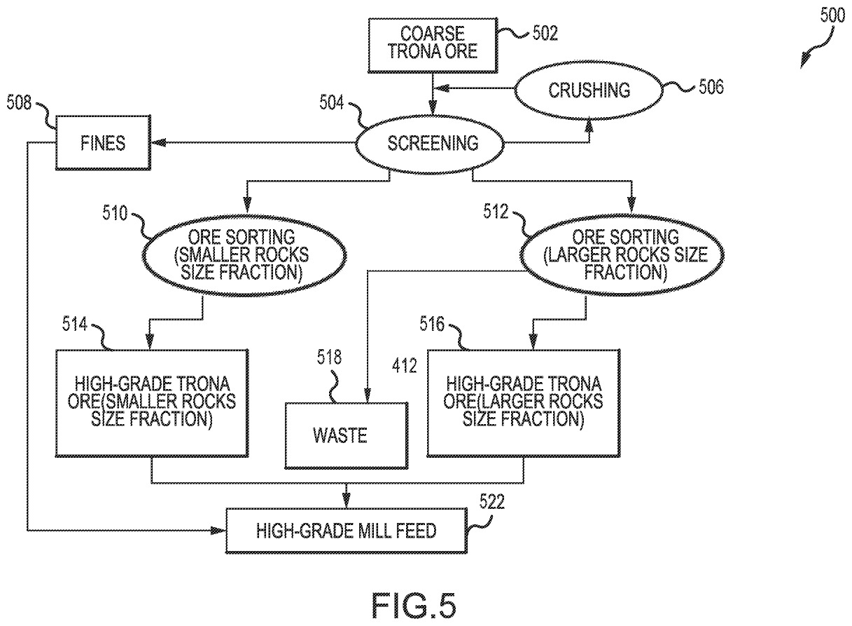

Similar to method 400, FIG. 5 is a flow diagram of a method 500 for the purification of trona, according to some embodiments. The method 500 for the purification of trona may utilize any of the ore sorting systems and/or assemblies disclosed herein. The method 500 may include act 502, which includes mining and/or harvesting coarse trona ore. The coarse trona ore can be mined by any suitable method known in the art to produce a crushable trona ore. Act 502 may be followed by act 504, which includes screening of trona ore and/or oversized rocks which can be introduced. Act 506 can include crushing of the trona ore to create a suitable rock size for the ore sorting process. The crushed ore is reintroduced into act 504. In some examples, act 506 of crushing may not be required if the rock size is adequate. In some examples, more crushing can be conducted to further improve the ore sorting processes described in act 510 and act 512.

In some examples, crushing the trona ore can include pulverizing a raw ore into an ore particle comprising a diameter between about ⅛ inch and about 4 inches. In some examples, these particles can be crushed to include diameters less than 12 inches. In other examples, the particles can include diameters less than 10 inches, less than 8 inches, less than 6 inches, less than 4 inches, or less than 2 inches. In some examples the particles crushed can include a particle size in ranges between about ⅛ inch and about 8 inches. Other ranges can include between about ⅛ inch and about 1 inch, between about 1 inch and about 3 inches, between about 3 inches and about 4 inches, between about 4 inches and about 6 inches, between about 6 inches and about 9 inches, between about 9 inches and about 12 inches, between about 3 inches and about 8 inches, or between about ½ inch and about 4 inches.

Acts 502, 504, and 506 of the method 500 are for illustrative purposes. For example, the acts of the method 500 may be performed in different orders, split into multiple acts, modified, supplemented, or combined. Act 506 includes screening trona ore to produce an ore feed comprising ore particles. The act 506 of screening may include utilizing any of the ore sorting assemblies or systems disclosed herein or other systems of screening and/or filtration known in the art. In some examples, act 506 may include screening to separate rock size. In some examples, the trona ore comprises fines as determined in act 508, which can be sent directly to a mill feed for further processing, smaller rock size fractions in act 510, and larger rock size fraction in act 512.

Act 510 including ore sorting for smaller rock size fraction and act 512 including ore sorting for larger rock size fraction can be conducted in parallel. In other words, the ore feed can include a first ore feed including a large ore particle diameter and a second ore feed including a small ore particle diameter. In some examples, the sorting of larger rock size fraction can produce a waste stream in Act 518. The waste stream of act 518 can be further crushed or processed, in some examples. In other examples, the waste can be disposed.

After ore sorting for rock size in acts 510 and 512, the ore sorting in acts 514 and 516 can include using a beneficiation system to determine the ore grade of the rock. For example, the beneficiation system can include at least one of density, magnetic, electrostatic, optical, X-ray, or infrared separation. The sensor can include an X-ray transmission (XRT) source configured to analyze the trona ore particles for their X-ray signal attenuations and determine atomic density of the trona ore particles. In some examples, the sensor can capture the transmitted X-rays and the data can be sent to a computer that is configured to use a pre-determined algorithm to decide whether to keep the particles or reject them as waste. In some examples, act 514 and act 516 can include identifying an impurity content of the ore particles by a beneficiation system. In some examples, the beneficiation system of the particle comprises utilizing X-ray transmission-based imaging to identify ore purity. In some examples, the first ore feed can be fed to a first beneficiation system and the second ore feed can be fed to a second beneficiation system. In some examples, the first beneficiation system and the second beneficiation system are in series. In other examples, the first beneficiation system and the second beneficiation system are in parallel.

In some examples, in acts 514 and 516, the trona ore is analyzed by purity and separated by grade of the trona ore. In some examples, the purity threshold can include about 90% trona. Acts 514 and 516 can be conducted via a beneficiation system that can include a sensor. The sensor can conduct the analysis instantaneously. The waste can be disposed in act 520 in some examples. In other examples, the waste can be further analyzed for either a different grade of trona ore and/or reevaluate to ensure proper ore sorting was conducted in acts 514 and 516. The high-grade trona from the ore sorting can be send to a high-grade mill feed in act 522 for further processing. In some examples, the further processing includes dissolution, solution purification, crystallization to produce sodium sesquicarbonate, and calcination to produce soda ash.

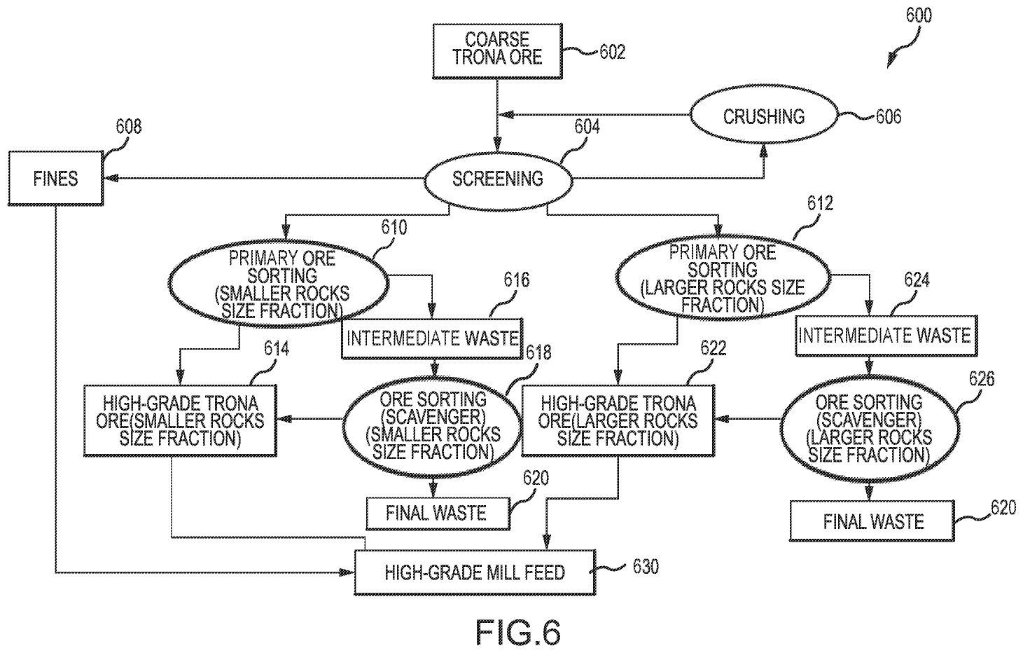

Similar to the methods 400 and 500, FIG. 6 is a flow diagram of a method 600 for the purification of trona, according to some embodiments. The method 600 for the purification of trona may utilize use any of the ore sorting systems and/or assemblies disclosed herein. The method 600 may include act 602, which includes mining and/or harvesting coarse trona ore. The coarse trona ore can be mined by any suitable method known in the art to produce a crushable trona ore. Act 602 may be followed by act 604, which includes screening of trona ore. Oversized rocks, depending on the system, can be introduced into act 606, which includes crushing of trona ore, to create a suitable rock size for the ore sorting process. The crushed ore is reintroduced into act 604. Act 606 may not be necessary if the rock size in act 602 is adequate to the rock size in act 602 is adequate to the ore sorter feed size in act 610 and 612.

In some examples, crushing the trona ore can include pulverizing a raw ore into an ore particle comprising a diameter between about ⅛ inch and about 4 inches. In some examples, these particles can be crushed to include diameters less than 12 inches. In other examples, the particles can include diameters less than 10 inches, less than 8 inches, less than 6 inches, less than 4 inches, or less than 2 inches. In some examples the particles crushed can include a particle size in ranges between about ⅛ inch and about 8 inches. Other ranges can include between about ⅛ inch and about 1 inch, between about 1 inch and about 3 inches, between about 3 inches and about 4 inches, between about 4 inches and about 6 inches, between about 6 inches and about 9 inches, between about 9 inches and about 12 inches, between about 3 inches and about 8 inches, or between about ½ inch and about 4 inches.

Acts 602 and 604 of the method 600 are for illustrative purposes. For example, the acts of the method 600 may be performed in different orders, split into multiple acts, modified, supplemented, or combined. Act 604 includes screening trona ore to produce an ore feed comprising ore particles. The act 604 of screening may include utilizing any of the ore sorting assemblies or systems disclosed herein or other systems of screening and/or filtration known in the art. In some examples, act 604 may include screening to separate rock size. In some examples, the trona ore is sorted in to fines as determined in act 608, which can be sent directly to a mill feed for further processing, smaller rock size fractions in act 610, and larger rock size fraction in act 612.

Act 610 including ore sorting for smaller rock size fraction and act 612 including ore sorting for larger rock size fraction can be conducted in parallel. In other words, the ore feed can include a first ore feed including a large ore particle diameter and a second ore feed including a small ore particle diameter. In some examples, the sorting of larger rock size fraction can produce a waste stream in Act 616 and a waste stream in act 624. The waste stream of act 616 and act 624 can be further processed and thus can be considered as intermediate waste, in some examples. For example, in act 618 and act 626 the waste can be further processed in a second beneficiation or “scavenger” step. The ore sorting in act 618 and act 626 can utilize a scavenger ore sorting system, used to further recover material that was mistakenly rejected as waste by mechanical error, to determine whether ore can be further recovered. In other words, to correct any misclassification of ore sorting in the beneficiation process, the waste ore is passed through another time or another beneficiation system to minimize waste and maximize trona ore production. In acts 620 and 628, the final waste can be disposed or processed as gangue material.

After ore sorting for rock size in acts 610 and 612, the ore sorting in acts 614 and 622 can include using a beneficiation system to determine the ore grade of the rock. For example, the beneficiation system can include at least one of density, magnetic, electrostatic, optical, X-ray, or infrared separation. In some examples, act 614 and act 622 can include identifying an impurity content of the ore particles by a beneficiation system. In some examples, the beneficiation system of the particle comprises utilizing X-ray transmission-based imaging to identify ore purity. In some examples, the first ore feed can be fed to a first beneficiation system and the second ore feed can be fed to a second beneficiation system. In some examples, the first beneficiation system and the second beneficiation system are in series. In other examples, the first beneficiation system and the second beneficiation system are in parallel.

The waste can be disposed in act 620 and act 628, in some examples. The high-grade trona from the ore sorting can be sent to a high-grade mill feed in act 630 for further processing. In some examples, the further processing includes dissolution, solution purification, crystallization to produce sodium sesquicarbonate, and calcination to produce soda ash.

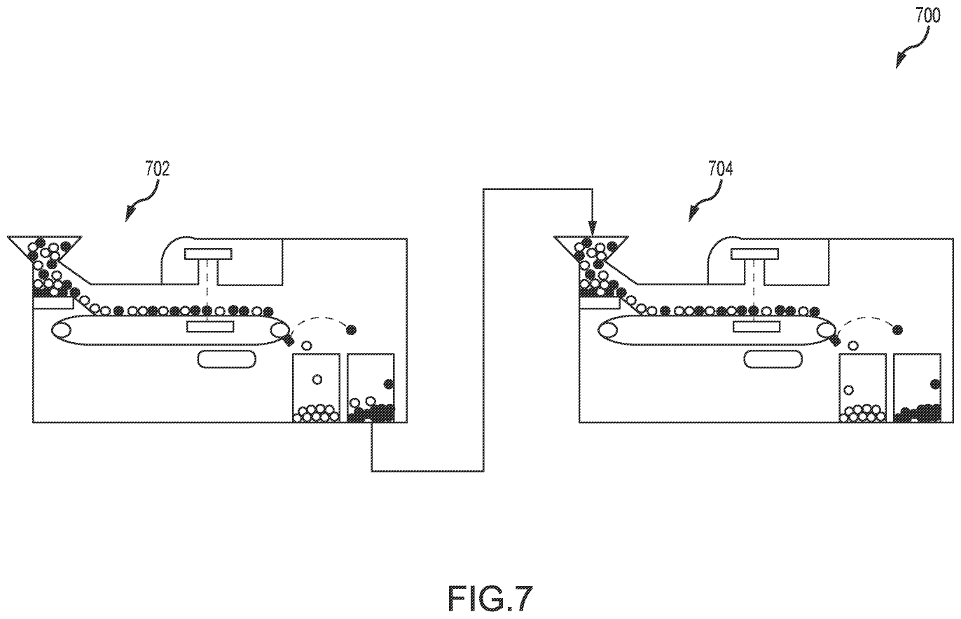

FIG. 7 is a side view of an ore-sorting system 700 using a first beneficiation system 702 and a second beneficiation system 704. In some examples, the second beneficiation system 704 can include a secondary XRT sensor, according to an embodiment. As shown, secondary ore sorter or second beneficiation system 704 is configured to analyze rejected trona ore particles to identify and further separate misclassified trona ore particles. In other words, the second beneficiation system 704 scavenges the trona ore particles that may have been rejected by the first beneficiation system 702.

### Example 1

In Example 1, trona ore samples were collected from a mining operation in Green River, Wyoming to assess the feasibility of removing waste rocks containing high amount of insoluble waste using X-ray transmission (XRT) based particle ore sorting. The samples were split into two size fractions: 0.315-0.787 inches (smaller size fraction) and 0.787 1.575 inches (larger size fraction). Waste content in ore in Example 1 is presented as % insolubles. Trona purity is reported where necessary.

Full scale XRT ore sorters were used to conduct the tests presented in Example 1. Ore sorting using XRT technology was very successful in rejecting waste rocks with an overall trona recovery of 98.2% while rejecting 8.5% of the original feed mass of both size fractions.

A sample of 641.5 lbs. of the smaller size fraction was fed into the XRT sorter containing 9.5% insolubles. 7.2% of the original feed mass was identified as waste and removed from the system. The waste rocks contained a high amount of waste at 77% insolubles. The final product, making up 92.8% of the original mass feed, contains a low amount of waste at 4.2% insolubles (trona purity of 95.8%). The overall trona recovery using ore sorting for the smaller size fraction is 98.2%.

A sample of 1402.1 lbs. of the larger size fraction was fed into the XRT sorter containing 10.8% insolubles. 9.1% of the original feed mass was identified as waste and removed from the system. The waste rocks contained a high amount of waste at 82.8% insolubles. The final product, making up 90.9% of the original mass feed, contains a low amount of waste at 3.6% insolubles (trona purity of 96.4%). The overall trona recovery using ore sorting for the larger size fraction is 98.2%.

Table 1 below summarizes the results from the trona ore sorting tests using XRT imaging technology.

TABLE 1

| Size | Feed | Mass Pull to | Product | Waste | Trona Sorter |
|---|---|---|---|---|---|
| Fraction | Grade | Product | Grade | Grade | Recovery |
| [inch] | [% Insolubles] | [%] | [% Insolubles] | [% Insolubles] | [%] |
| 0.315-0.787 | 9.49 | 92.8 | 4.21 | 77.0 | 98.2 |
| 0.787-1.575 | 10.84 | 90.9 | 3.62 | 82.8 | 98.2 |
| 0.315-1.575 | 10.41 | 91.5 | 3.81 | 81.25 | 98.2 |

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean±10%, ±5%, or +2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

We claim:

1. An ore-sorting system, comprising:
a trona ore screen system comprising an ore crusher and a filter, the screen system configured to produce an ore feed comprising ore particles having a predetermined size;
a beneficiation system to receive the ore particles having a predetermined size, the beneficiation system configured to increase an economic value of the trona ore by removing gangue material, resulting in a high-grade ore product, the beneficiation system comprising a sensor and a separator, wherein the separator comprises an identification system configured to accept or reject ore, wherein accepted ore is deposited in a bin and rejected ore is ejected with a high-pressure air jet.

2. The ore sorting system of claim 1, wherein the trona ore comprises trona interbedded with at least one of a marlstone, limestone, oil shale, sandstone, or mudstone.

3. The ore sorting system of claim 1, wherein the ore crusher pulverizes a raw ore into an ore particle comprising a diameter between about ⅛ inch and about 4 inches.

4. The ore sorting system of claim 1, wherein the sensor identifies trona ore having a trona concentration greater than 95%.

5. The ore sorting system of claim 1, wherein the beneficiation system comprises a dry separation including at least one of density, magnetic, electrostatic, optical, X-ray, or infrared separation.

6. The ore sorting system of claim 1, wherein the separator comprises a first trona ore feed including a large ore particle diameter and a second ore feed including a small ore particle diameter, wherein the first ore feed is fed to a first beneficiation system and the second ore feed is fed to a second beneficiation system.

7. The ore sorting system of claim 6, wherein the first trona ore feed and second trona ore feed are in series.

8. The ore sorting system of claim 6, wherein the first trona ore feed and second trona ore feed are in parallel.

9. An ore-sorting system, comprising:
a feed intake comprising a hopper configured to receive trona ore particles;
a conveyer belt that receives the trona ore particles from the hopper and carries the trona ore particles to be evaluated, wherein the trona ore particles are configured as a monolayer on the conveyer belt;
a sensor configured to examine the trona ore particles on the conveyor belt to evaluate the concentration of trona in the trona ore particles and identify a high-grade ore product; and
an ore separator to divide the high-grade ore product from a waste material based on the results of the sensor.

10. The ore sorting system of claim 9, wherein the sensor comprises an XRT source configured to analyze the trona ore particles for their X-ray signal attenuations and determine atomic density of the trona ore particles.

11. The ore sorting system of claim 9, wherein the ore separator comprises an identification system configured to accept or reject each trona ore particle, wherein an accepted trona ore particle is deposited in a bin and a rejected trona ore particle is ejected with a high-pressure air jet.

12. The ore sorting system of claim 11, further comprising a secondary ore sorter, wherein the secondary ore sorter is configured to analyze rejected trona ore particles to identify and further separate misclassified trona ore particles.

13. A method for purification of trona, the method comprising:
screening trona ore to produce an ore feed comprising ore particles having a predetermined size;
identifying an impurity content of the ore particles by a beneficiation system to receive the ore particles having a predetermined size, the beneficiation system configured to increase an economic value of the trona ore by removing gangue material, resulting in a high-grade ore product; and
separating the ore particles using air-jet diverters based on a purity threshold, wherein an accepted ore is deposited in a bin and rejected ore is ejected with a high-pressure air jet.

14. The method of claim 13, wherein beneficiation of the particle comprises utilizing X-ray transmission-based imaging to identify ore purity.

15. The method of claim 13, wherein the ore feed comprises ore particles having a diameter between about ⅛ inch and about 4 inches.

16. The method of claim 13, wherein the purity threshold comprises about 90% trona.

17. The method of claim 13, further comprising crushing the trona ore prior to screening trona ore.

18. The method of claim 13, wherein the ore feed comprises a first ore feed including a large ore particle diameter and a second ore feed including a small ore particle diameter, wherein the first ore feed is fed to a first beneficiation system and the second ore feed is fed to a second beneficiation system.

19. The method of claim 18, wherein the first beneficiation system and the second beneficiation system are in series.

20. The method of claim 18, wherein the first beneficiation system and the second beneficiation system are in parallel.
